(19) United States
(12) Patent Application Publication
(10) Pub. No.: US 2010/0282545 A1
(43) Pub. Date: Nov. 11, 2010

(54) ELEVATOR DEVICE

(75) Inventor: Takaharu Ueda, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, TOKYO (JP)

(21) Appl. No.: 12/812,609

(22) PCT Filed: Apr. 15, 2008
(86) PCT No.: PCT/JP2008/057325

§ 371 Date: Jul. 13, 2010

(51) Int. Cl. B66B 1/28

(52) U.S. Cl. 187/248

(57) ABSTRACT

In an elevator device, a car is raised and lowered by a plurality of hoisting machines respectively including hoisting machine brakes. Each of the hoisting machine brakes has a braking force large enough to stop the car by itself. Each of a plurality of brake control sections respectively for controlling the corresponding hoisting machine brakes includes a plurality of calculation sections. The calculation sections can detect a failure of the calculation sections by comparing own results of calculations and cause a corresponding one of the hoisting machine brakes to perform a braking operation upon detection of the failure of the calculation sections.

### TECHNICAL FIELD

The present invention relates to an elevator device which raises and lowers a car by a plurality of hoisting machines.

### BACKGROUND ART

In a conventional elevator device, a car is raised and lowered by a first hoisting machine including a first brake device and a second hoisting machine including a second brake device. The first brake device includes first, second, and third brake main bodies. The second brake device includes fourth, fifth, and sixth brake main bodies. The first and fourth brake main bodies belong to a first group, the second and fifth brake main bodies belong to a second group, and the third and sixth brake main bodies belong to a third group. For emergency braking, timings of generation of braking forces by the first to sixth brake main bodies are shifted for each group, whereby the car can be prevented from being subjected to an excessive deceleration rate (for example, see Patent Document 1).

### DISCLOSURE OF THE INVENTION

### Problem to be Solved by the Invention

When the first and second brake devices are to be controlled by a plurality of calculation sections in the elevator device in which the common car is raised and lowered by the first and second hoisting machines as described above, it is desired to more reliably stop the car even when a failure occurs in the calculation sections.

The present invention is devised to solve the problem described above, and has an object of providing an elevator device which can more reliably stop a car even when a failure occurs in calculation sections.

### MEANS FOR SOLVING THE PROBLEM

According to the present invention, there is provided an elevator device including: a plurality of hoisting machines including driving sheaves, motors for rotating the driving sheaves, and hoisting machine brakes for braking rotation of the driving sheaves, respectively; suspending means wound around the driving sheaves; a car suspended by the suspending means, the car being raised and lowered by the plurality of hoisting machines; and a plurality of brake control sections for controlling the corresponding hoisting machine brakes, respectively, in which each of the hoisting machine brakes has a braking force large enough to stop the car by itself, each of the plurality of brake control sections includes a plurality of calculation sections, and the plurality of calculation sections are capable of detecting a failure of the plurality of calculation sections by comparing own results of calculations and cause a corresponding one of the hoisting machine brakes to perform a braking operation upon detection of the failure of the plurality of calculation sections.

Further, according to the present invention, there is provided an elevator device including: a first hoisting machine including a first driving sheave, a first motor for rotating the first driving sheave, and a first brake device and a second brake device for braking rotation of the first driving sheave; a second hoisting machine including a second driving sheave, a second motor for rotating the second driving sheave, and a third brake device and a fourth brake device for braking rotation of the second driving sheave; suspending means wound around the first driving sheave and the second driving sheave; a car suspended by the suspending means, the car being raised and lowered by the first hoisting machine and the second hoisting machine; a first brake control section for controlling the second brake device and the third brake device; and a second brake control section for controlling the first brake device and the fourth brake device, in which each of a set of the second brake device and the third brake device and a set of the first brake device and the fourth brake device has a braking force large enough to stop the car by itself, each of the first brake control section and the second brake control section includes a plurality of calculation sections, the plurality of calculation sections are capable of detecting a failure of the plurality of calculation sections by comparing own results of calculations, the first brake control section causes the second brake device and the third brake device to perform a braking operation upon detection of a failure of the plurality of calculation sections, and the second brake control section causes the first brake device and the fourth brake device to perform a braking operation upon detection of a failure of the plurality of calculation sections.

Further, according to the present invention, there is provided an elevator device including: a plurality of hoisting machines including driving sheaves, motors for rotating the driving sheaves, and hoisting machine brakes for braking rotation of the driving sheaves, respectively; suspending means wound around the driving sheaves; a car suspended by the suspending means, the car being raised and lowered by the plurality of hoisting machines; and a plurality of brake control sections for controlling the corresponding hoisting machine brakes, respectively, in which each of the plurality of brake control sections includes a plurality of calculation sections, and the plurality of calculation sections are capable of detecting a failure of the plurality of calculation sections by comparing own results of calculations and cause all of the hoisting machine brakes to perform a braking operation upon detection of the failure of the plurality of calculation sections.

### BRIEF DESCRIPTION OF THE DRAWINGS

FIG. 1 is a configuration diagram illustrating an elevator device according to a first embodiment of the present invention.

FIG. 2 is a circuit diagram illustrating a principal part of the elevator device illustrated in FIG. 1.

FIG. 3 is a configuration diagram illustrating the elevator device according to a second embodiment of the present invention.

FIG. 4 is a circuit diagram illustrating the principal part of the elevator device according to a third embodiment of the present invention.

FIG. 5 is a circuit diagram illustrating the principal part of the elevator device according to a fourth embodiment of the present invention.

### BEST MODE FOR CARRYING OUT THE INVENTION

Hereinafter, preferred embodiments of the present invention are described referring to the drawings.

### First Embodiment

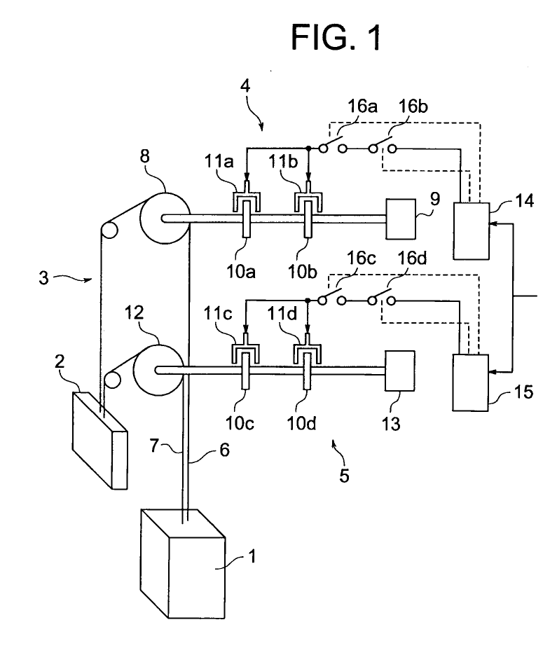

FIG. 1 is a configuration diagram illustrating an elevator device according to a first embodiment of the present invention. In the drawing, a car 1 and a counterweight 2 are suspended by suspending means 3 in a hoistway, and are raised and lowered by driving forces of a first hoisting machine 4 and a second hoisting machine 5. The suspending means 3 includes at least one first main rope 6 and at least one second main rope 7. As each of the first main rope 6 and the second main rope 7, a rope having a circular cross section or a belt-like rope is used.

The first hoisting machine 4 includes: a first driving sheave 8; a first motor 9 for rotating the first driving sheave 8; a first brake wheel 10a and a second brake wheel 10b which are rotated integrally with the first driving sheave 8; and a first brake device 11a and a second brake device 11b for respectively braking the rotation of the first brake wheel 10a and that of the second brake wheel 10b.

The second hoisting machine 5 includes: a second driving sheave 12; a second motor 13 for rotating the second driving sheave 12; a third brake wheel 10c and a fourth brake wheel 10d which are rotated integrally with the second driving sheave 12; and a third brake device 11c and a fourth brake device 11d for respectively braking the rotation of the third brake wheel 10c and that of the fourth brake wheel 10d.

A first hoisting machine brake for braking the rotation of the first driving sheave 8 includes the first brake device 11a and the second brake device 11b. A second hoisting machine brake for braking the rotation of the second driving sheave 12 includes the third brake device 11b and the fourth brake device 11d. The first hoisting machine brake has a braking force large enough to stop the car 1 by itself. The second hoisting machine brake has a braking force large enough to stop the car 1 by itself.

Each of the brake devices 11a, 11b, 11c, and 11d includes: a brake shoe moved into contact with and separated away from a corresponding one of the brake wheels 10a, 10b, 10c, and 10d; a brake spring for pressing the brake shoe against the corresponding one of the brake wheels 10a, 10b, 10c, and 10d; and an electromagnet for separating the brake shoe from the corresponding one of the brake wheels 10a, 10b, 10c, and 10d against the brake spring. As the brake wheels 10a, 10b, 10c, and 10d, brake discs are used, for example.

The first brake device 11a and the second brake device 11b are controlled by a first brake control section 14. The third brake device 11c and the fourth brake device 11d are controlled by a second brake control section 15. The first brake control section 14 controls opening/closing of a first electromagnetic switch 16a and a second electromagnetic switch 16b for turning ON/OFF electric power supply to the electromagnets of the first brake device 11a and the second brake device 11b. The second brake control section 15 controls opening/closing of a third electromagnetic switch 16c and a fourth electromagnetic switch 16d for turning ON/OFF electric power supply to the electromagnets of the third brake device 11c and the fourth brake device 11d.

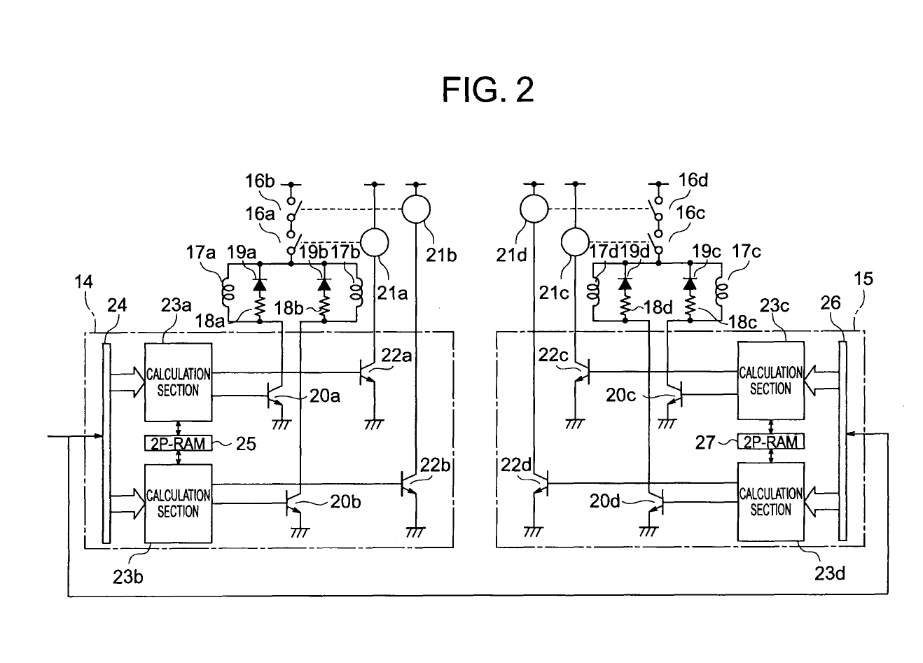

FIG. 2 is a circuit diagram illustrating a principal part of the elevator device illustrated in FIG. 1.

First, a circuit configuration relating to the first brake control section 14 is described. A first brake coil (a first electromagnetic coil) 17a is provided to the electromagnet of the first brake device 11a. A second brake coil (a second electromagnetic coil) 17b is provided to the electromagnet of the second brake device 11b.

The first brake coil 17a and the second brake coil 17b are connected in parallel to a power source. The first electromagnetic switch 16a and the second electromagnetic switch 16b are connected in series between the first brake coil 17a and the second brake coil 17b, and the power source.

A circuit, in which a first discharge resistor 18a and a first discharge diode 19a are connected in series, is connected in parallel to the first brake coil 17a. A circuit, in which a second discharge resistor 18b and a second discharge diode 19b are connected in series, is connected in parallel to the second brake coil 17b.

A first braking-force control switch 20a is connected between the first brake coil 17a and a ground. A second braking-force control switch 20b is connected between the second brake coil 17a and the ground. As the first braking-force control switch 20a and the second braking-force control switch 20b, semiconductor switches are used, for example.

By turning ON/OFF the first braking-force control switch 20a and the second braking-force control switch 20b, currents flowing respectively through the first brake coil 17a and the second brake coil 17b are controlled to control the degrees of application of the braking forces of the first brake device 11a and the second brake device 11b, respectively.

The first electromagnetic switch 16a is opened and closed by a first driving coil 21a. An end of the first driving coil 21a is connected to a power source. The other end of the first driving coil 21a is connected to the ground through an intermediation of a first electromagnetic-switch control switch 22a.

The second electromagnetic switch 16b is opened and closed by a second driving coil 21b. An end of the second driving coil 21b is connected to a power source. The other end of the second driving coil 21b is connected to the ground through an intermediation of a second electromagnetic-switch control switch 22b. As the first electromagnetic-switch control switch 22a and the second electromagnetic-switch control switch 22b, semiconductor switches are used, for example.

The first braking-force control switch 20a and the first electromagnetic-switch control switch 22a are controlled to be turned ON/OFF by a first calculation section (a first computer) 23a. The second braking-force control switch 20b and the second electromagnetic-switch control switch 22b are controlled to be turned ON/OFF by a second calculation section (a second computer) 23b. Each of the first calculation section 23a and the second calculation section 23b includes a microcomputer.

Signals from various sensors and an operation control section are input to the first calculation section 23a and the second calculation section 23b through a data bus 24. The first calculation section 23a and the second calculation section 23b perform calculation processing for controlling the first brake device 11a and the second brake device 11b based on programs stored therein and the input signals.

Moreover, a dual-port RAM 25 is connected between the first calculation section 23a and the second calculation section 23b. The first calculation section 23a and the second calculation section 23b exchange their own data through the dual-port RAM 25 to compare the results of calculations with each other, thereby detecting the occurrence of a failure in any one of the first calculation section 23a an the second calculation section 23b.

Next, a circuit configuration relating to the second brake control section 15 is described. A third brake coil (a third electromagnetic coil) 17c is provided to the electromagnet of the third brake device 11c. A fourth brake coil (a fourth electromagnetic coil) 17d is provided to the electromagnet of the fourth brake device 11d.

The third brake coil 17c and the fourth brake coil 17d are connected in parallel to a power source. The third electromagnetic switch 16c and the fourth electromagnetic switch 16d are connected in series between the third brake coil 17c and the fourth brake coil 17d, and the power source.

A circuit, in which a third discharge resistor 18c and a third discharge diode 19c are connected in series, is connected in parallel to the third brake coil 17c. A circuit, in which a fourth discharge resistor 18d and a fourth discharge diode 19d are connected in series, is connected in parallel to the fourth brake coil 17d.

A third braking-force control switch 20c is connected between the third brake coil 17c and a ground. A fourth braking-force control switch 20d is connected between the fourth brake coil 17d and the ground. As the third braking-force control switch 20c and the fourth braking-force control switch 20d, semiconductor switches are used, for example.

By turning ON/OFF the third braking-force control switch 20c and the fourth braking-force control switch 20d, currents flowing respectively through the third brake coil 17c and the fourth brake coil 17d are controlled to control the degrees of application of the braking forces of the third brake device 11c and the fourth brake device 11d, respectively.

The third electromagnetic switch 16c is opened and closed by a third driving coil 21c. An end of the third driving coil 21c is connected to a power source. The other end of the third driving coil 21c is connected to the ground through an intermediation of a third electromagnetic-switch control switch 22c.

The fourth electromagnetic switch 16d is opened and closed by a fourth driving coil 21d. An end of the fourth driving coil 21d is connected to a power source. The other end of the fourth driving coil 21d is connected to the ground through an intermediation of a fourth electromagnetic-switch control switch 22d. As the third electromagnetic-switch control switch 22c and the fourth electromagnetic-switch control switch 22d, semiconductor switches are used, for example.

The third braking-force control switch 20c and the third electromagnetic-switch control switch 22c are controlled to be turned ON/OFF by a third calculation section (a third computer) 23c. The fourth braking-force control switch 20d and the fourth electromagnetic-switch control switch 22d are controlled to be turned ON/OFF by a fourth calculation section (a fourth computer) 23d. Each of the third calculation section 23c and the fourth calculation section 23d includes a microcomputer.

Signals from various sensors and an operation control section are input to the third calculation section 23c and the fourth calculation section 23d through a data bus 26. The third calculation section 23c and the fourth calculation section 23d perform calculation processing for controlling the third brake device 11c and the fourth brake device 11d based on programs stored therein and the input signals.

Moreover, a dual-port RAM 27 is connected between the third calculation section 23c and the fourth calculation section 23d. The third calculation section 23c and the fourth calculation section 23d exchange their own data through the dual-port RAM 27 to compare the results of calculations with each other, thereby detecting the occurrence of a failure in any one of the third calculation section 23c an the fourth calculation section 23d.

Next, an operation of the first brake control section 14 is described. The operation control section transmits a brake operation command to the first brake control section 14 according to start/stop of the car 1. Upon issuance of the brake operation command, the first calculation section 23a and the second calculation section 23b respectively turn ON the first electromagnetic-switch control switch 22a and the second electromagnetic-switch control switch 22b. As a result, the first driving coil 21a and the second driving coil 21b are excited to close the first electromagnetic switch 16a and the second electromagnetic switch 16b.

By turning ON/OFF the first braking-force control switch 20a and the second braking-force control switch 20b in this state, the excited states of the first brake coil 17a and the second brake coil 17b are controlled to control the braking states of the first brake device 11a and the second brake device 11b. Moreover, the first calculation section 23a and the second calculation section 23b apply a control command, for example, a command for continuous ON/OFF according to a required current, to the first braking-force control switch 20a and the second braking-force control switch 20b.

In case of an emergency stop of the car 1, the first calculation section 23a and the second calculation section 23b control the currents of the first brake coil 17a and the second brake coil 17b by ON/OFF of the braking-force control switches 20a and 20b while referring to a signal from a speed detection section (not shown) so that a rotating speed of the first driving sheave 8, that is, a speed of the car 1 follows a target speed pattern. A deceleration pattern is set so that a deceleration rate does not become excessively high.

Moreover, when the results of calculations by the first calculation section 23a and the second calculation section 23b differ from each other, it is believed that at least any one of the first calculation section 23a and the second calculation section 23b has failed. Therefore, the first calculation section 23a generates a command for opening the first electromagnetic switch 16a, and the second calculation section 23b generates a command for opening the second electromagnetic switch 16b. As a result of opening of at least any one of the first electromagnetic switch 16a and the second electromagnetic switch 16b, the first brake device 11a and the second brake device 11b immediately perform a braking operation without controlling the deceleration rate.

Next, an operation of the second brake control section 15 is described. The operation control section transmits a brake operation command to the first brake control section 15 according to start/stop of the car 1. Upon issuance of the brake operation command, the third calculation section 23c and the fourth calculation section 23d respectively turn ON the third electromagnetic-switch control switch 22c and the fourth electromagnetic-switch control switch 22d. As a result, the third driving coil 21c and the fourth driving coil 21d are excited to close the third electromagnetic switch 16c and the fourth electromagnetic switch 16d.

By turning ON/OFF the third braking-force control switch 20c and the fourth braking-force control switch 20d in this state, the excited states of the third brake coil 17c and the fourth brake coil 17d are controlled to control the braking states of the third brake device 11c and the fourth brake device 11d. Moreover, the third calculation section 23c and the fourth calculation section 23d apply a control command, for example, a command for continuous ON/OFF according to a required current, to the third braking-force control switch 20c and the fourth braking-force control switch 20d.

In case of an emergency stop of the car 1, the third calculation section 23c and the fourth calculation section 23d control the currents of the third brake coil 17c and the fourth brake coil 17d by ON/OFF of the braking-force control switches 20c and 20d while referring to a signal from a speed detection section so that a rotating speed of the second driving sheave 12, that is, a speed of the car 1 follows a target speed pattern. A deceleration pattern is set so that a deceleration rate does not become excessively high.

Moreover, when the results of calculations by the third calculation section 23c and the fourth calculation section 23d differ from each other, it is believed that at least any one of the third calculation section 23c and the fourth calculation section 23d has failed. Therefore, the third calculation section 23c generates a command for opening the third electromagnetic switch 16c, and the fourth calculation section 23d generates a command for opening the fourth electromagnetic switch 16d. As a result of opening of at least any one of the third electromagnetic switch 16c and the fourth electromagnetic switch 16d, the third brake device 11c and the fourth brake device 11d immediately perform a braking operation without controlling the deceleration rate.

In the elevator device as described above, each of the first and second hoisting machine brakes has the braking force large enough to stop the car 1 by itself. Upon detection of the failure of any one of the calculation sections 23a, 23b, 23c, and 23d, the first brake control section 14 and the second brake control section 15 cause the corresponding hoisting machine brake to perform the braking operation. Thus, even when the failure occurs in the calculation sections 23a, 23b, 23c, and 23d, the car 1 can be more reliably stopped.

### Second Embodiment

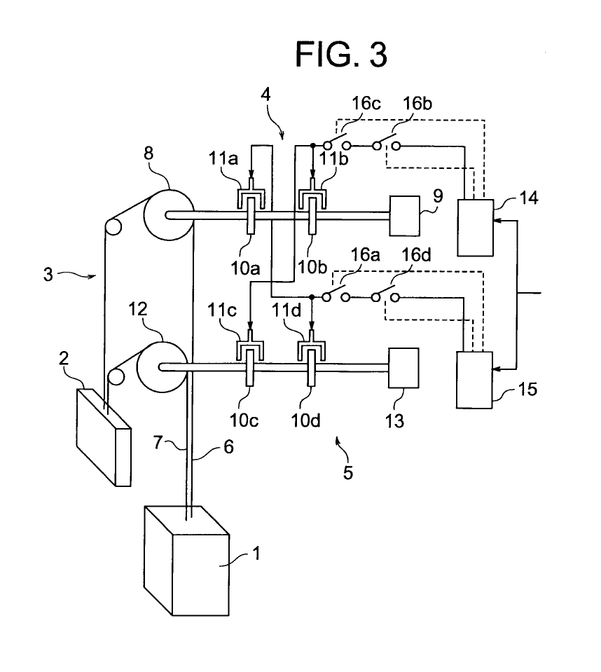

Next, FIG. 3 is a configuration diagram illustrating the elevator device according to a second embodiment of the present invention. In the drawing, each of a set of the second brake device 11b and the third brake device 11c and a set of the first brake device 11a and the fourth brake device 11d has the braking force large enough to stop the car 1 by itself. Upon detection of a failure of any one of the first calculation section 23a and the second calculation section 23b, the first brake control section 14 causes the second brake device 11b and the third brake device 11c to perform the braking operation. Upon detection of a failure of any one of the third calculation section 23c and the fourth calculation section 23d, the second brake control section 15 causes the first brake device 11a and the fourth brake device 11b to perform the braking operation.

Specifically, the configuration is obtained by interchanging the first driving coil 21a for opening and closing the first electromagnetic switch 16a and the third driving coil 21c for opening and closing the third electromagnetic switch 16c with each other in FIG. 2. Substantially, the configuration is the same as a configuration in which the first brake device 11a and the third brake device 11c illustrated in FIG. 1 are interchanged with each other in the circuit configuration illustrated in FIG. 2. The remaining configuration and operation are the same as those of the first embodiment.

In the elevator device as described above, even when the failure occurs in the calculation sections 23a, 23b, 23c, and 23d, the car 1 can be more reliably stopped.

Furthermore, upon detection of the failure of the calculation sections 23a, 23b, 23c, and 23d, the braking force is applied to both the first driving sheave 8 and the second driving sheave 12. Therefore, the imbalance of the braking force can be suppressed, and hence the car 1 can be stably stopped.

### Third Embodiment

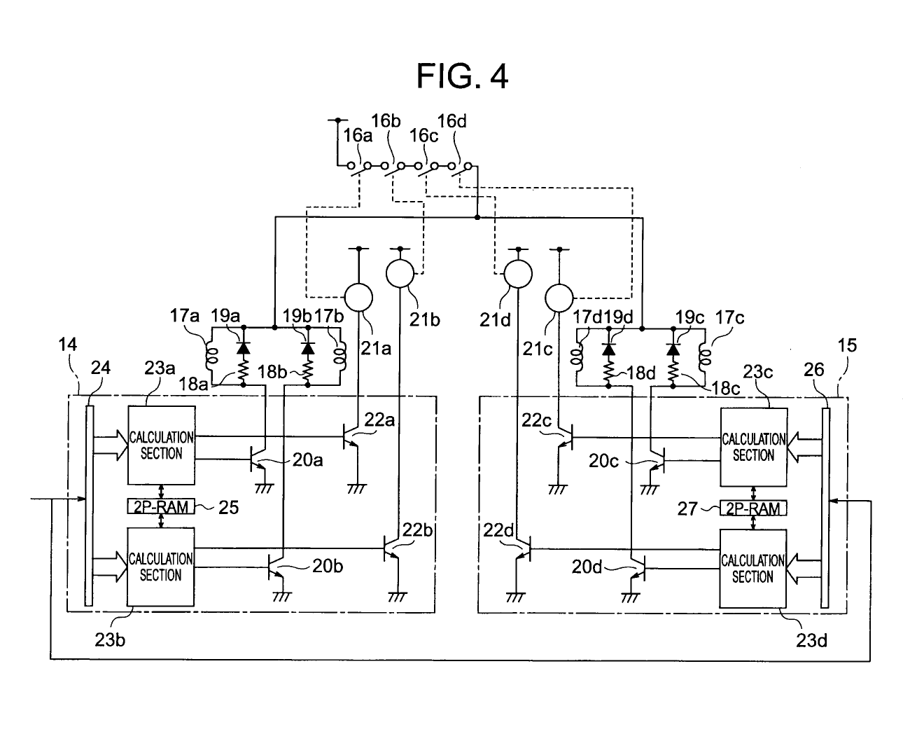

Next, FIG. 4 is a circuit diagram illustrating the principal part of the elevator device according to a third embodiment of the present invention. In the drawing, the first to fourth electromagnetic switches 16a to 16d are connected in series between the first to fourth brake coils 17a to 17d and the power source. Therefore, when any one of the electromagnetic switches 16a to 16d is opened, all the brake devices 11a, 11b, 11c, and 11d are de-energized. The remaining configuration and operation are the same as those of the first embodiment.

In the elevator device described above, when the failure occurs in the calculation sections 23a, 23b, 23c, and 23d, all the brake devices 11a, 11b, 11c, and 11d are de-energized. Thus, the car 1 can be more reliably stopped. Furthermore, the braking force (a braking torque) of each of the brake devices 11a, 11b, 11c, and lid can be made smaller than that of each of the first and second embodiments.

### Fourth Embodiment

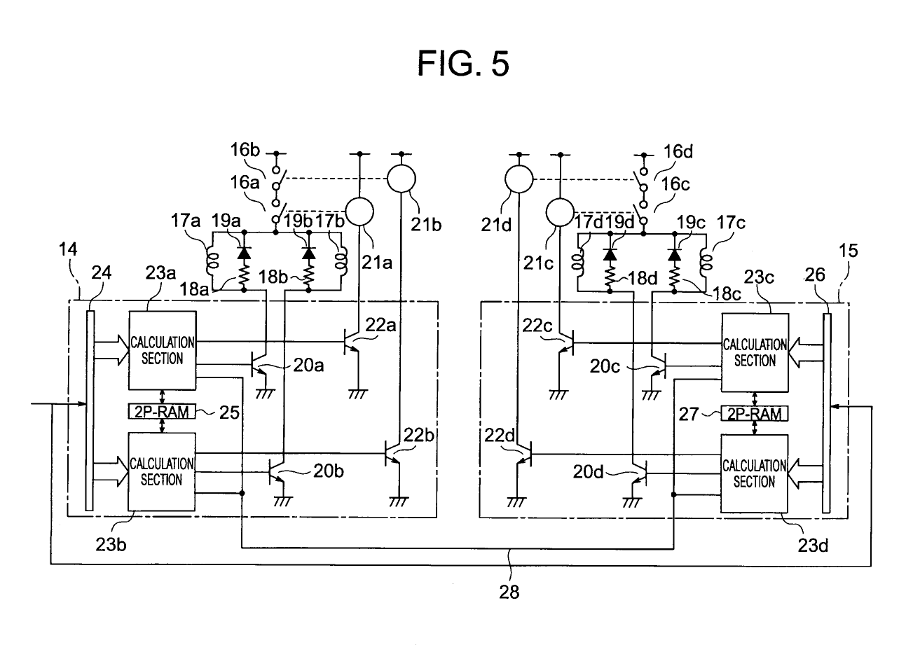

Next, FIG. 5 is a circuit diagram illustrating the principal part of the elevator device according to a fourth embodiment of the present invention. In the drawing, the first calculation section 23a and the second calculation section 23b, and the third calculation section 23c and the fourth calculation section 23d are connected to each other through communication means 28 so that communication can be performed therebetween.

Upon detection of the failure of the first calculation section 23a and the second calculation section 23b, the first calculation section 23a generates a command for opening the first electromagnetic switch 16a and the second calculation section 23b generates command for opening the second electromagnetic switch 16b while transmitting failure detection information to the first calculation section 23c and the fourth calculation section 23d through the communication means 28. As a result, the first calculation section 23c generates a command for opening the third electromagnetic switch 16c, and the fourth calculation section 23d generates a command for opening the fourth electromagnetic switch 16d.

Upon detection of the failure of the third calculation section 23c and the fourth calculation section 23d, the third calculation section 23c generates a command for opening the third electromagnetic switch 16c and the fourth calculation section 23d generates command for opening the fourth electromagnetic switch 16d while transmitting failure detection information to the first calculation section 23a and the second calculation section 23b through the communication means 28. As a result, the first calculation section 23a generates a command for opening the first electromagnetic switch 16a, and the second calculation section 23b generates a command for opening the second electromagnetic switch 16b. The remaining configuration and operation are the same as those of the first embodiment.

In the elevator device described above, when the failure occurs in the calculation sections 23a, 23b, 23c, and 23d, all the brake devices 11a, 11b, 11c, and 11d are de-energized. Thus, the car 1 can be more reliably stopped. Furthermore, the braking force (a braking torque) of each of the brake devices 11a, 11b, 11c, and 11d can be made smaller than that of each of the first and second embodiments.

Furthermore, each of the electromagnetic switches 16a to 16d is required to be used to function for the electric power supplied to each of all the brake coils 17a to 17d in the third embodiment, and hence the device cannot be reduced in size. On the other hand, it is sufficient that each of the electromagnetic switches is used to function for the electric power supplied to either one of sets of two of the brake coils 17a to 17d in the fourth embodiment, and hence the device can be relatively reduced in size.

Although the car 1 is raised and lowered by the two hoisting machines 4 and 5 in the examples described above, three or more hoisting machines may also be used.

Moreover, although the set of the two brake devices 11a and 11b and the set of the two brake devices 11c and 11d are respectively used for the hoisting machines 4 and 5 in the examples described above, one, three or more brake devices may also be used.

1. An elevator device comprising:
a plurality of hoisting machines including driving sheaves, motors for rotating the driving sheaves, and hoisting machine brakes for braking rotation of the driving sheaves, respectively;
suspending means wound around the driving sheaves;
a car suspended by the suspending means, the car being raised and lowered by the plurality of hoisting machines; and
a plurality of brake control sections for controlling the corresponding hoisting machine brakes, respectively,
wherein each of the hoisting machine brakes has a braking force large enough to stop the car by itself,
each of the plurality of brake control sections includes a plurality of calculation sections, and
the plurality of calculation sections are capable of detecting a failure of the plurality of calculation sections by comparing own results of calculations and cause a corresponding one of the hoisting machine brakes to perform a braking operation upon detection of the failure of the plurality of calculation sections.

2. An elevator device comprising:
a first hoisting machine including a first driving sheave, a first motor for rotating the first driving sheave, and a first brake device and a second brake device for braking rotation of the first driving sheave;
a second hoisting machine including a second driving sheave, a second motor for rotating the second driving sheave, and a third brake device and a fourth brake device for braking rotation of the second driving sheave;
suspending means wound around the first driving sheave and the second driving sheave;
a car suspended by the suspending means, the car being raised and lowered by the first hoisting machine and the second hoisting machine;
a first brake control section for controlling the second brake device and the third brake device; and
a second brake control section for controlling the first brake device and the fourth brake device,
wherein each of a set of the second brake device and the third brake device and a set of the first brake device and the fourth brake device has a braking force large enough to stop the car by itself,
each of the first brake control section and the second brake control section includes a plurality of calculation sections,
the plurality of calculation sections are capable of detecting a failure of the plurality of calculation sections by comparing own results of calculations,
the first brake control section causes the second brake device and the third brake device to perform a braking operation upon detection of a failure of the plurality of calculation sections, and
the second brake control section causes the first brake device and the fourth brake device to perform a braking operation upon detection of a failure of the plurality of calculation sections.

3. An elevator device comprising:
a plurality of hoisting machines including driving sheaves, motors for rotating the driving sheaves, and hoisting machine brakes for braking rotation of the driving sheaves, respectively;
suspending means wound around the driving sheaves;
a car suspended by the suspending means, the car being raised and lowered by the plurality of hoisting machines; and
a plurality of brake control sections for controlling the corresponding hoisting machine brakes, respectively,
wherein each of the plurality of brake control sections includes a plurality of calculation sections, and
the plurality of calculation sections are capable of detecting a failure of the plurality of calculation sections by comparing own results of calculations and cause all of the hoisting machine brakes to perform a braking operation upon detection of the failure of the plurality of calculation sections.

4. An elevator device according to claim 3, further comprising a plurality of electromagnetic switches for turning ON/OFF electric power supply to the hoisting machine brakes,
wherein the plurality of electromagnetic switches are connected to each other in series, and
upon detection of the failure of the plurality of calculation sections, the plurality of brake control sections turn OFF a corresponding one of the plurality of electromagnetic switches.

5. An elevator device according to claim 3, wherein
the plurality of brake control sections are connected to each other through communication means so that communication there between is enabled, and
upon detection of the failure of the plurality of calculation sections, one of the plurality of brake control sections transmits failure detection information to another one of the plurality of brake control sections.
